(19) United States
(12) Patent Application Publication
(10) Pub. No.: US 2025/0376368 A1
(43) Pub. Date: Dec. 11, 2025

(54) Drum Emptying Rotating Station

(71) Applicant: Unibloc Hygienic Technologies UK, Ltd., Bolney (GB)

(72) Inventor: Robert George Grantham-Hill, Southwater (GB)

(73) Assignee: Unibloc Hygienic Technologies UK, Ltd., Bonley (GB)

(21) Appl. No.: 19/194,648

(22) Filed: Apr. 30, 2025

Related U.S. Application Data
(60) Provisional application No. 63/656,354, filed on Jun. 5, 2024.

(51) Int. Cl. B67D 7/62; B67D 7/78

(52) U.S. Cl. CPC B67D 7/62; B67D 7/78

(57) ABSTRACT

A drum emptying station provides a rotatable stand disposed below a pump supported by two bases and an elevationally movable shoulder. The pump is selectively lowered into containers with viscous product to remove product from the containers. A seal can precede the pump into containers to assist in scraping sides of the containers, and a linear slide coupled to the rotatable stand can assist in precisely locating containers at desired positions relative to the pump to facilitate product removal.

### CLAIM OF PRIORITY

This application claims the benefit of U.S. Provisional Patent Application No. 63/656,354 filed Jun. 5, 2024, which is incorporated herein by reference in its entirety.

### FIELD OF THE INVENTION

The present invention relates to a drum emptying station, and more particularly, to a drum emptying station configured to empty a pallet of multiple drums, utilizing the station in an efficient manner.

### BACKGROUND OF THE INVENTION

The applicant's recently issued U.S. Pat. No. 11,840,443, incorporated herein by reference, provided a cantilveredly supported lance movable to selected positions over a plurality of totes and/or drums. FIG. 6 of that reference chows the possibility of providing a turntable below a lance. This design has a lance lowering into the drum. The lance is in a fixed lateral position relative to the turntable, and the pallet rotates relative to the lance. The lance then moves vertically in and out of the drum. This design is quite suitable for low viscosity products. Higher viscosity products may prove to be problematic with such a construction.

Accordingly, for at least some uses, improvements over the prior art are believed to be beneficial.

### SUMMARY OF THE INVENTION

It is a present object of many embodiments of the present invention to provide a pneumatic system for pumping and also vertically moving or controlling the movement of a pump and seal relative to various drums.

It is another object of many embodiments of the present invention is to provide an unloading station with a pump which lowers and raises relative to a turntable of containers positioned there below.

It is another object of many embodiments of the present invention to provide a pump which raises and lowers with an seal over a portion of a rotatable stand having drums of material therein.

Accordingly, in accordance with a presently preferred embodiment of the present invention, an unloading station is provided having a rotatable stand supporting at least one, if not a plurality, such a plurality on a pallet of drums which are rotatable below a pump which is raised and lowered relative to specific drums, preferably in combination with a seal which “scrapes” the sides of the drum which can be particularly effective at removing viscous material from drums.

The pump is preferably supported by a frame having a lift to which the pump/seal combination is connected. The lift moves vertically relative to the frame thereby lifting and lowering the pump/seal combination vertically.

A pallet of goods is placed on the rotatable stand and rotated to a desired position relative to the pump/seal. The pump/seal is then lowered to the top of a selected drum and then, the pump is activated to begin pumping the material. The pump continues to be downwardly directed into the drum as the material is removed, preferably with the seal scraping the materially downwardly toward the inlet of the pump until the drum is sufficiently emptied. The pump can then be lifted with the seal from the container, the rotatable stand rotated to accommodate the next drum, and the process repeated.

The unloading station of the applicant may be more compact at the base support than many prior art configurations. The unloading station is also believed to rely upon pneumatic controls rather than electric sensors used in prior art systems.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front perspective view of the presently preferred embodiment of a drum unloading station of the present invention;

FIG. 2 is a front plan view of the drum unloading station of FIG. 1;

FIG. 3 is a top plan view of the embodiment of FIG. 1; and

FIG. 4 is a side plan view of the embodiment of FIG. 1.

### DETAILED DESCRIPTION OF THE PREFERRED EMBODIMENTS

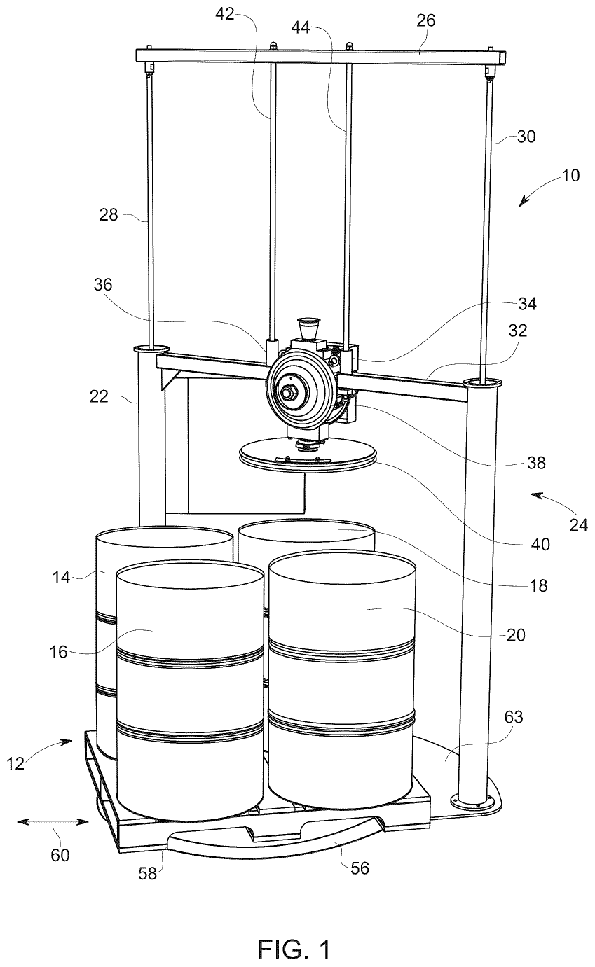

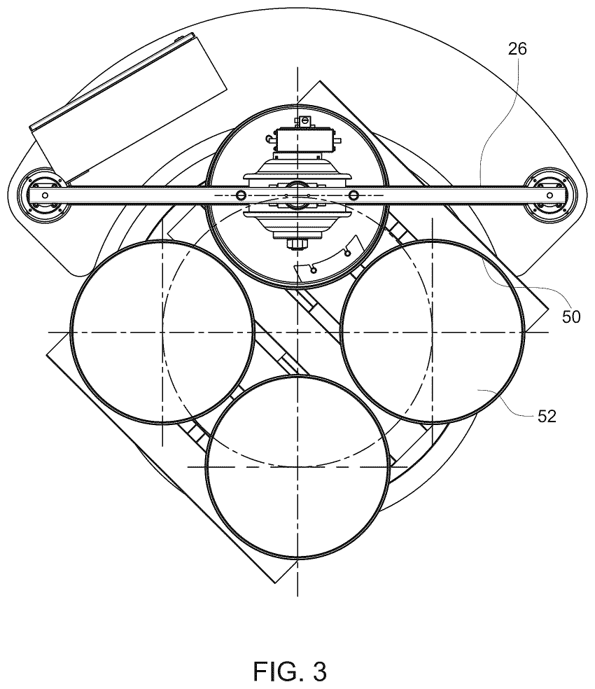

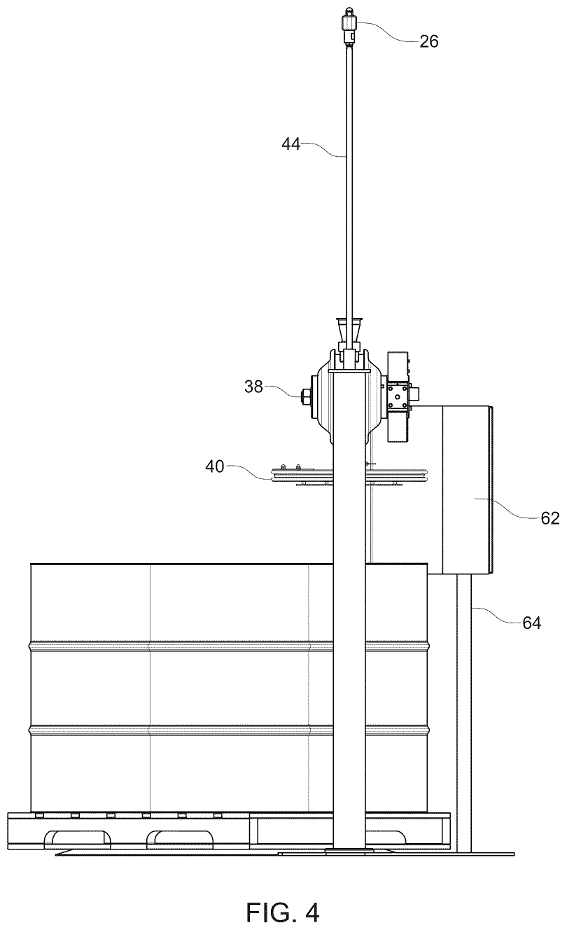

FIGS. 1-4 show a drum emptying station 10 of a presently preferred embodiment of the present invention. The station 10 can accommodate a pallet 12 of drums 14,16,18,20. Other embodiments may accommodate totes or other containers as will be explained in further detail below.

The station 10 preferably has two bases 22,24 which, preferably, supports a shoulder 26 which may selectively be raised and lowered relative to bases 22,24 such as with lift rods 28,30. The lift rods 28,30 may move like pistons relative to bases 22,24 for many embodiments to move the arm 26 linearly up and down, aka vertically. Strut 32 may connect bases 22,24 together for stability and provide guides 34,36 for providing linear movement of the pump 38 and/or seal 40 as they are downwardly directed with arms 42,44 downwardly extending from shoulder 26 towards and into a drum such as drum 18 (or other) shown below the pump 38. Guides may be bores and/or other structures which assist arms 42,44 in linearly directing the pump 38 and/or seal 40 up and down in the drums 14-20 as well as into and out of the drums 14-20 thereby permitting positioning of the next drum in a desired location relative to the pump 38 and/or seal 40 for emptying of the next drum 14-20.

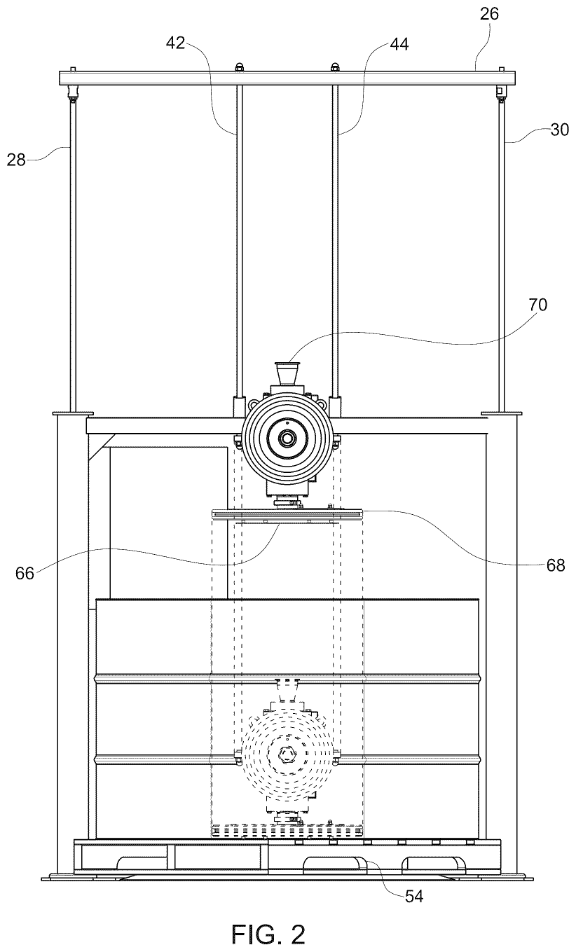

FIG. 2 shows the pump 38 and seal 40 in phantom as they would be when lowered down into drum 18. Controller 62 may be used to at least raise, if not lower the pump 38 and/or start/stop the pump 38. Seal 40 may connect to the bottom portion of the pump 38 and may provide an inflatable seal in an effort to attempt to ensure recovery of viscous product as it ‘scrapes’ the interior drum wall 50 as it lowers. The weight of the pump 38 and/or seal 40 may be sufficient to continue to downwardly direct the pump 38 and seal 40 into the volume 52 of the drums 14-20 as they are pumped or the lift arms 28,30 may apply a downward force to direct shoulder 26 downwardly along with arms 42,44 and thus, pump 38 and seal 40 into the volume and down toward a bottom 54 of drums 14-20 as they are unloaded.

Pallet 12 is supported on rotatable stand 56 so that a drum selected from the group of drums 14-20, etc., may be unloaded, and the stand 56 with the drums 14-20 may be rotated to accommodate a different one of the drums 14-20 for unloading, etc. Rotatable stand 56 may also have linear slide 58 so as to assist in positioning any of the drums 14-20 directly under the pump 38 and/or seal 40 such as along axis 60, or other axis, particularly if the pallet 12 is not loaded in perfect alignment as expected when rotating the rotatable stand 56 relative to the pump 38 and/or seal 40.

For at least some embodiments, pump 38 and/or seal are restrained for linear movement vertically only by guides 34,36 and arms 42,44 as moved by or with shoulder 26.

For ease of installation for at least some embodiments, bases 22,24 are secured to platform 62 along with rotatable stand, and possibly linear slide 58. Controller 62 may also be connected to platform 63 such as with a post 64 to provide at a more convenient working height for operators.

Pump inlet 66 is preferably at a bottom surface of seal 40. Seal 40 may have an inflating outer edge 68 to assist in scraping the inner surfaces 50 of the drums 14-20 during the emptying step.

As viscous or other material is removed from the drum, such material is directed through pump outlet and piping 70 to a desired location.

When provided in the embodiment shown in the drawings, a station 10 can easily be installed on location and be ready for operation extremely quickly.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. A drum emptying station comprising:
first and second bases supporting a shoulder therebetween;
a rotatable stand located below the shoulder rotatable about an axis;
wherein said shoulder is selectively movable elevationally between an upper and a lower position, said shoulder connected to a pump; wherein a container of product is placed on the rotatable stand with the container located positioned below the pump, and the pump is lowered from the upper position above the container to the lower position, and while in the lower position, the pump is operated thereby removing at least some product from the container.

2. The drum emptying station of claim 1 wherein when in the lower position, the pump is located within the container.

3. The drum emptying station of claim 2 wherein the container is a drum.

4. The drum emptying station of claim 3 wherein a pallet of drums is provided on the rotatable stand and selectively rotated to selectively position one of the drums below the pump when in the upper position, and then the pumps is lowered to the lower position to remove product from the one of the drums.

5. The drum emptying station of claim 1 further comprising a linear slide coupled to the rotatable stand whereby the container is movable linearly with the linear slide relative to the rotatable stand thereby assisting in positioning the container at a desired position below the pump.

6. The drum emptying station of claim 5 wherein the container is one container of a plurality of containers on a pallet, and wherein the linear slide moves the pallet of containers linearly.

7. The drum emptying station of claim 1 further comprising linear guides which restrict movement of the pump to up and down.

8. The drum emptying station of claim 1 further comprising a seal disposed below the pump whereby the seal contacts the container while removing product from the container.

9. The drum emptying station of claim 8 wherein the seal is located within the container while removing product from the container.

10. The drum emptying station of claim 9 wherein the seal has an inflatable edge which contacts internal portions of the container when removing product from the container.

11. The drum emptying station of claim 1 further comprising a platform supporting the bases and rotatable stand.

12. The drum emptying station of claim 11 wherein the platform supports a controller, said controller directing at least upward movement of the pump toward the upper position as well as turning the pump on.
